(19) United States
(12) Patent Application Publication
(10) Pub. No.: US 2003/0229625 A1
(43) Pub. Date: Dec. 11, 2003

(54) Structured query language processing integrated circuit and distributed database processor

(76) Inventors: Timothy Allan Melchior, Colorado Springs, CO (US); Diane Lynn Mohammadi-Zand, Colorado Springs, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/163,652

(22) Filed: Jun. 6, 2002

(51) Int. Cl. G06F 7/00

(52) U.S. Cl. 707/3

(57) ABSTRACT

A distributed SQL database management system includes an SQL-processing integrated circuit capable of processing industry standard SQL commands. The SQL-processing integrated circuit includes a content addressable memory engine and resolves queries at a high abstraction level. The use of the SQL integrated circuit and distributed SQL database management system significantly increases memory bandwidth. The SQL integrated circuit performs the following SQL functions: table joins, view support, learning mode extension, proximity match extension, longest prefix match extension, SQL DML support, SQL table manipulation, SQL view manipulation, SQL transaction control, SQL security, and partial SQL DDL support.

### BACKGROUND OF THE INVENTION

This invention pertains to Structured Query Language (“SQL”) database management systems and, more particularly, to an improved distributed SQL database management system including a dedicated SQL-processing integrated circuit.

Until now, it has not been technically feasible to create an SQL-processing integrated circuit (“IC”), and all current SQL database management systems are implemented in software on a host processor. Several important technology trends have recently occurred which make it possible to realize an SQL IC and distributed database management system according to the present invention.

The cost of memory has steadily become more affordable. The price per byte of memory has plummeted over the past few years while memory density has grown dramatically. Today a single memory DIMM containing up to two gigabytes of memory is available and memory prices have fallen to twenty-five cents per megabyte. This means it is now practical to maintain and manage multi-gigabyte databases in random-access memory (“RAM”).

Memory capacity has also increased. State-of-the-art 512 megabit DRAM chips are being released to production in 2002. These chips will double existing practical memory depths. Already several gigabytes of memory is common in a system.

Integrated circuit technology has now advanced to accommodate a “system on a chip”. It is now possible to build a complex system, consisting of millions of gates of logic, on a single IC. With the advent of 0.25 micron silicon technology a few years ago, it became practical to fabricate millions of gates of logic on a single IC. Today, 0.18, 0.15, and even 0.13 micron silicon fabrication is common. It is reasonable to expect that the evolution of hardware systems will follow a similar path to that of software systems. Since software database systems were the first applications, outside of operating systems, to be packaged and sold as a commodity, it is reasonable to assume that the first commodity system on an IC may be a database system, although no such system on an IC has yet been produced.

Concurrently, technology advances in other areas have heightened the need for a higher performance database solution.

These technology advances have increased demand for decision support. With ever-increasing complexity in business, there is a growing demand for decision support systems to derive information from massive corporate data warehouses.

Today the World Wide Web is everywhere. The explosive growth of the Web has dramatically impacted business. Web servers are now connected to thousands of users all demanding near instantaneous access. Most web sites involved in e-commerce or information dispersal have a growing need for high performance database solutions.

After years of mere conjecture and speculation, machine vision has now become practical. With the modern day advent of charge-coupled device (“CCD”) integrated circuits and high speed processing, machine vision is now the first practical and broadly used artificial intelligence application.

Fundamental to all information systems is the organization and retrieval of information. Nearly all modern information systems use an SQL-processing relational database to accomplish this. In many systems, database activity represents a significant performance bottleneck. Database programs such as Oracle, DB2 and SQL Server compete with one another, each claiming superior performance statistics. Thus, it is evident that database performance is key to information systems.

These companies all approach the database management problem as a software problem. Referring now to FIG. 1, a typical software-based database management system 10 implemented on a host processor includes a number of different application programs 12A, 12B, and 12C such as Enterprise Resource Planning (“ERP”), Online Analytical Processing (“OLAP”), or Business To Business (“B2B”) systems that communicate with an open data base connectivity interface 16 (“ODBC”), which is typically used for connectivity to a wide range of back end databases and a wide range of front-ends. A database administrator 14 communicates with host database software 18, which in turn maintains a checkpoint file 22, a journal file 24, and one or more database files 26A and 26B.

Today, high performance application objectives are either not being met or are being satisfied at considerable cost with the software-based SQL database management systems described above with respect to FIG. 1.

Higher performance database processing is required for Information Management, which is the largest and most established of the database market segments. This market segment contains both transaction based and data mining applications. Most database management activity is found in this market segment. The two largest information system application groups are ERP and OLAP Systems. ERP systems use databases to manage corporate manufacturing, financial, inventory, and personnel information. Improved system response time and a greater transaction rate with less computer server resources are desired. Processing historical data using an OLAP system can be very lookup intensive. A single high-level query can result in millions of elemental database queries. Therefore, an OLAP system is desired that can more quickly perform data analysis and that can provide better and faster decision support.

Better performance is required in “e-business”, “e-commerce” and B2B systems. The constraining factor for these systems, which facilitate Internet business, is their transaction rate. As additional users access an Internet site, the increased traffic can slow response time. What is desired is a new database system that will allow e-business sites to support a significant increase in simultaneous users without degrading performance.

The performance of new Intelligent Systems can be improved to enhance Artificial Intelligence (“AI”) applications. While current database technology does well what humans do poorly—organize huge databases and correlate and extract subsets of the data—current technology is unable to quickly do what comes naturally to humans—interpret observations and make decisions.

Similarly, it is desirable to enhance the performance of current Recognition Systems. Tedious and error prone manufacturing and food inspection duties could be accelerated. A very low cost solution to the recognition and decision aspects of robotics is also desirable.

Security systems now perform fingerprint identification, voice recognition, facial recognition, retina scan identification and other data-intensive tasks designed to improve domestic security. What is desired is a solution that will allow bioinformatic security systems to process images more quickly and support larger subject databases.

Bioinformatic research systems all stress the current database technology to its limits. This includes the promising human genome analysis, which must be accelerated to satisfy the growing demands of genetic research.

Many new medical analysis techniques can be greatly accelerated by automated examination of digitized images of biological material. It is desirable to accelerate the diagnosis of cancer, genetic diseases, and infectious diseases beyond that which is available with current software-based management systems.

Environmental Analysis could also be improved. Satellite imagery data, both spatial and spectral, is generated today in huge quantities. Enormous volumes of this data must be quickly analyzed. This data cannot be currently analyzed using SQL-processing because SQL is unable to find “close matches”. With the advent of increased biological threats, the ability to quickly analyze sensory data is becoming ever more critical.

Military Reconnaissance could also be improved. Target recognition is a key AI function the military must carry out with extreme speed and accuracy. In military applications, it is desirable to improve the processing performance, but it is also necessary that the database system be implemented with a low power and small footprint solution. Current software-based SQL database management systems require these objectives to be compromised.

Telecommunications database processing could also be improved. Telecommunications processing today includes ultra-high traffic, transaction oriented, large database systems.

Finally, the database processing capacity of today's hand-held and embedded systems is constrained by the power consumption performance curve inherent in general purpose processors. In such compact systems it would be highly desirable to process database information at tremendous speeds. Current mainstream databases are fundamentally disk-based systems with RAM caching for acceleration. Several new in-memory systems purport to accelerate database processing by running entirely in memory. Indeed, memory is now dense enough and economical enough for this to be practical.

All software-based SQL database systems are significantly hindered by the memory access bottleneck that has kept database performance from accelerating at a rate that is even close to the rate of integrated circuit processor performance gains.

Therefore, what is desired is an integrated circuit-based SQL database system that will significantly increase speed and performance, lower power requirements, and offer the possibility of embedded and portable product implementations.

### SUMMARY OF THE INVENTION

According to the present invention, by moving the core of the database function into silicon, an SQL-processing integrated circuit can be created that accelerates query resolution and reduces memory accesses and thus I16 dramatically outperforms current database technology. This SQL-processing integrated circuit and corresponding distributed database management system approaches database management as a hardware problem. Any system requiring extremely fast queries or handling a very high volume of query dependant traffic will benefit from the dramatic performance improvements of the SQL-processing IC.

The present invention uses system-on-a-chip technology to create an SQL-processing IC capable of processing industry standard SQL commands. The SQL-processing IC builds upon the proven UTCAM-Engine IC (see U.S. Pat. Nos. 6,226,710 and 6,353,873) and resolves queries at a high abstraction level, effectively increasing the memory bandwidth when compared with current approaches. This greatly increases the real performance capabilities of computers and opens the door to much more intelligent and powerful applications.

The database features of the SQL-processing IC include: table joins; view support; b-tree and hash table support; learning mode; proximity match support; longest prefix match support; SQL DML support; SQL table manipulation; SQL view manipulation; SQL transaction control; SQL security; and partial SQL DDL support, among other features.

The SQL-processing IC is useful in both high-end servers and in compact hand-held devices. In one embodiment, one or more SQL-processing ICs reside on a system expansion card. In another embodiment, an integrated IC consisting of the SQL processor system of the present invention and a system expansion bus interface resides on a system expansion card. In another embodiment, the IC-based management system of the present invention is implemented on a system motherboard. In yet another embodiment, the IC-based management system of the present invention is embedded in a processor chip-set on a system motherboard. In one hand- held embodiment, the IC-based management system of the present invention is embedded in a single integrated circuit with a general purpose processor core and a memory controller. All embodiments communicate with application programs through a host ODBC interface.

There is a cost/performance advantage associated with the IC-based database management system of the present invention. Each SQL-processing IC is capable of performing about 100 times as much elemental database work as an expensive state of the art Intel processor and memory chip set at less than half the cost. For applications that have enough work to keep one or more SQL-processing ICs busy, this is a significant cost advantage.

There is a customized hardware advantage associated with the IC-based database management system of the present invention. The SQL-processing IC of the present invention is optimized for SQL-processing. A general purpose processor, such as the Intel Pentium, performs a plethora of tasks and can not be expected to perform any one of them as well as customized hardware. While this is true of virtually any function performed by a processor, it should be noted that, for many applications, data manipulation is a huge portion of the overall activity.

There is a distributed parallel processing advantage associated with the IC-based database management system of the present invention. In a typical database application, a query is the natural elemental partition of work. A query is a high level construct that generally derives information from data or updates a database by performing numerous elemental operations against a set of data. The system of the present invention, with one or more SQL-processing ICs is able to distribute database query processing from the central processing unit (“CPU”). A typical high performance database system will ideally perform numerous queries in parallel, using numerous SQL-processing ICs to create a low cost distributing processing environment. This approach frees up CPU cycles on the host processor while queries are being resolved. Typically these cycles can be used to perform high level application tasks which otherwise would have to wait for the CPU to complete its query processing activity.

There is also a memory capacity advantage associated with the IC-based database management system of the present invention. As memory is added to a data bus, the bus loading increases. This reduces the switching speed of the data bus. Registers reduce the loading at the expense of additional clock cycles of latency. It can quickly become impractical to drive huge amounts of memory. An embodiment of the present invention, which uses multiple SQL-processing ICs, distributes the data load across many buses, allowing the system to drive substantially more memory than would be practical with a traditional single data bus architecture. Each SQL-processing IC addresses up to 32 GB of memory or even more if required. As memory densities continue to increase and costs continue to decrease, this feature will become increasingly attractive.

The above and other objects, features, and advantages of the present invention will become more readily apparent when the following description is read in conjunction with the accompanying drawings.

### BRIEF DESCRIPTION OF THE DRAWINGS

FIG. 1 is a prior art block diagram of a prior art software-based SQL database management system resident on a host processor;

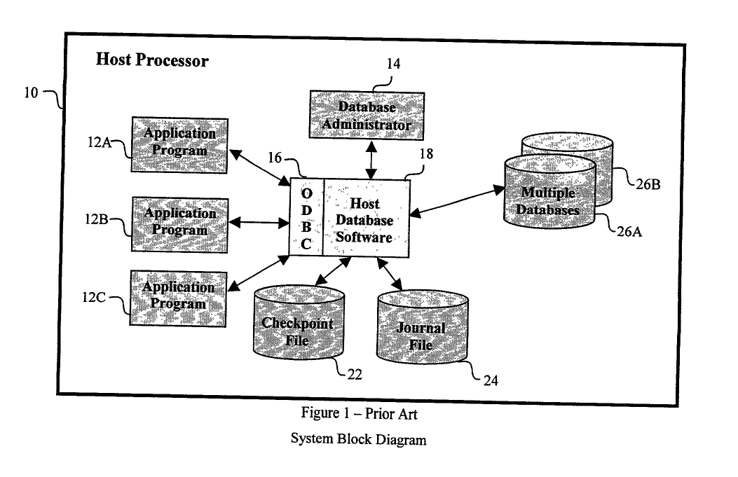

FIG. 2 is a data flow diagram of an IC-based SQL database management system according to the present invention;

FIG. 3 is a data flow diagram of a dedicated SQL integrated circuit optimized for SQL-processing and associated external database memory;

FIG. 4 is a further block diagram of the database system of the present invention in which the hierarchy of SQL commands is generally associated with three corresponding portions of the system;

FIG. 5 is a hardware block diagram of an expansion card embodiment of the present invention;

FIG. 6 is a hardware block diagram of an integrated expansion card embodiment of the present invention;

FIG. 7 is a hardware block diagram of a system motherboard embodiment of the present invention;

FIG. 8 is a hardware block diagram of an embedded silicon embodiment of the present invention; and

FIG. 9 is a hardware block diagram of a hand-held embodiment of the present invention.

### DETAILED DESCRIPTION OF THE INVENTION

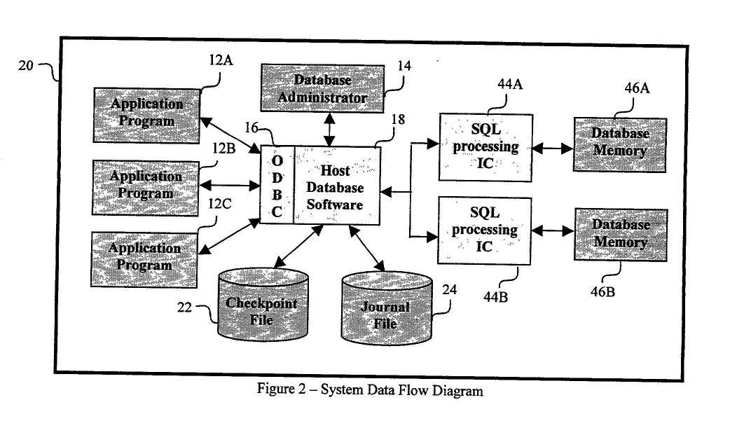

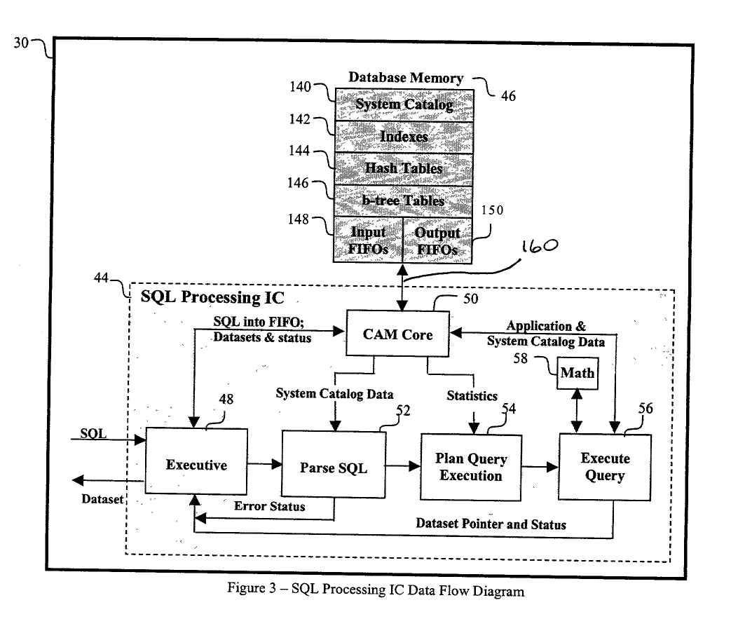

Referring now to FIG. 2, a system data flow diagram of an IC-based SQL database management system 20 is shown in which a number of different application programs 12A, 12B, and 12C are installed such as ERP, OLAP or B2B systems that communicate with an ODBC interface 16. A database administrator 14 communicates with host database software 18, which, in turn, maintains a checkpoint file 22, a journal file 24, and communicates with one or more dedicated SQL-processing integrated circuits 44A and 44B, which are in communication with the corresponding database memories 46A and 46B. A block diagram 30 of the SQL-processing IC 44 and associated external database memory 46 is shown in FIG. 3. The SQL-processing IC 44 receives SQL commands from the host database software 18 and either starts them in the SQL-processing IC's pipeline or.stores them in a FIFO 148in either on-chip memory or in the database memory 46.

The SQL-processing IC 44 shown in FIG. 3 includes the following circuit blocks: an executive logic block 48 in communication with external host database software 18; a parse SQL logic block or “parser” 52 in communication with the executive logic block 48; a plan query execution logic block 54 in communication with the parser 52; an execute query logic block 56 in communication with the plan query execution logic block 54 and the executive logic block 48; and a math processor 58 in communication with the execute query logic block 56. A content-addressable memory (“CAM”) engine or CAM core 50 is in communication with logic blocks 48, 52, 54, and 56, as well as external database memory 46. A suitable candidate for CAM core 50 is the core designed and taught in U.S. Pat. No. 6,226,710 entitled “CONTENT ADDRESSABLE MEMORY (CAM) ENGINE” and U.S. Pat. No. 6,353,873 entitled “APPARATUS AND METHOD TO DETERMINE A LONGEST PREFIX MATCH IN A CONTENT ADDRESSABLE MEMORY”, which are both hereby incorporated by reference. All logic blocks referenced above can be built with CMOS combinatorial logic and can be integrated into a common silicon substrate with the CAM core 50 and math processor 58. Math processor 58 can also be fabricated using CMOS logic from a design library such as the Synopsis Design Ware library or the like.

A single bidirectional data bus 160 coupled to the external memory 46 is shown in FIG. 3. While one data bus 160 is shown coupled to a single database memory 46, data bus 160 can be divided into multiple data buses coupled to multiple database memories as desired. Ideally, three different buses 160 and memories 46 can be used: one for FIFOs 148 and 150; one for the system catalogs 140; and one for the rest of the database memory.

As soon as the parser output has been registered, the next command is passed to the SQL parser 52. The initial parse process is performed in combinatorial logic in conjunction with queries performed by the CAM core against the system catalog tables 140 contained in external database memory 46. This process determines if the SQL command is valid and identifies database dependent fields such as views, table names and column names. These fields are validated and translated to internal representation using the system catalog table 140 stored in the external database memory 46. If an error is found, the resulting error status is returned to the executive state machine 48 that stores the error status in an appropriate output FIFO 150 entry.

If the parse is successful, the tokenized SQL query is passed to the optimizer 54 where a query execution plan is devised. The query execution plan specifies how table joins are solved and executed. This module uses statistics stored in the system catalog 140 of the external database memory 46 when the Analyze command has run. These statistics assist the optimizer 54 to make good choices in the order in which queries are resolved.

Once the query execution plan is devised, it is passed to the next stage of the pipeline—the query execution module 56. This module executes the plan by pipelining commands through a core designed using U.S. Pat. Nos. 6,226,710 and 6,353,873, as referenced above.

The query results and dataset status are stored in the output FIFO 150 of the external database memory 46 as shown in FIG. 3 and are retrieved and removed from the output FIFO 150 by the executive module 48 when requested by the external host database software 18.

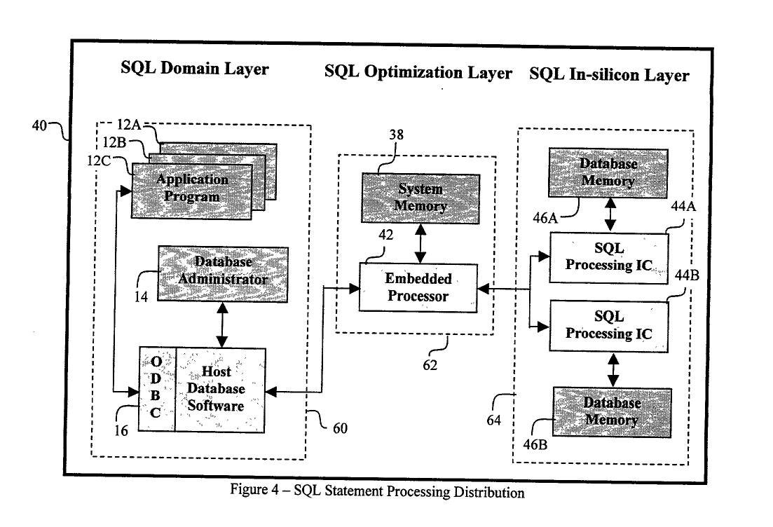

The SQL-processing integrated circuit or circuits 44A and 44B handles a subset of the SQL language and control statements represented by the SQL in-silicon layer 64 as shown in FIG. 4. These are the performance sensitive statements that a database processing application program uses. A select set of the SQL Data Definition Language (“DDL”) and SQL Data Manipulation Language (“DML”) statements are supported by the SQL-processing IC 44. These statements have been selected because their timely execution is critical for high performance SQL-processing and because they interface directly with the system catalog table 140.

In FIG. 4, the distributed system 40 is divided into the SQL domain section 60, operating on the host processor 118, the SQL optimization section 62, operating on the host processor 118 or the embedded processor 126, and the in-silicon SQL-processing layer 64, operating on the SQL processor IC 44 as is explained in further detail below. Each of these portions of the distributed database management system 40 handles selected SQL statements, generally based on the frequency at which these statements are accessed. The SQL domain statements are the least accessed and are handled by the SQL domain section 60. The SQL in-silicon statements are the most accessed and are handled by the SQL in-silicon section 64. Intermediately accessed statements are responsible for SQL optimization and are processed in the SQL optimization section 62. In some embodiments, where there is no embedded processor 126, the optimization statements are handled by the host processor 118.

The following statements are processed by the SQL domain section 60: User Authentication; Create Database; Alter Database; Drop Database; and Backup & Recovery statements such as Checkpoint, Journal, Backup, and Restore.

The following statements are processed by the SQL optimization section 62 or, in embodiments where there is no embedded processor 62, by the host processor 60: Optimization Analysis statements such as Analyze Table and Analyze Database; Audit; Stored Procedure statements such as Create Procedure, Alter Procedure, Drop Procedure, Create Trigger, Alter Trigger, Drop Trigger, Create Package, Alter Package, Drop Package, Create Package Body, Alter Package Body, and Drop Package Body.

The following statements are time critical, accessed frequently, and tightly integrated with the system catalog and are thus processed in the SQL in-silicon section 64: Data Manipulation DML statements such as Insert, Select, Update and Delete; Table Manipulation DDL statements such as Create Table, Alter Table, Drop Table and Truncate Table; View Manipulation DDL statements such as Create View, Alter View and Drop View; Security statements such as Create User, Alter User, Drop User, Create Profile, Alter Profile, Drop Profile, Create Role, Alter Role, Drop Role, Grant and Revoke; and Transaction Control statements such as Commit, Rollback, Savepoint and Set Transaction.

The SQL domain section 60 consists of a conventional processor in a PC or server that runs a conventional operating system and includes applications programs 12A, 12B, and 12C, database administrator 14, ODBC 16, and host database software 18 as described above. The host processor has access to a disk drive and thus is essential for maintaining data persistence. It also is the domain where multi-threaded and multi-user operations are performed.

All application programs, including database administration, run on the host processor 118. These applications validate user identification and pass the tagged query to the system expansion card using a standard ODBC interface 16.

The SQL optimization section 62 includes an embedded processor 42 and corresponding system memory 38, all resident on a system expansion card. The system expansion card's onboard embedded processor 42 offloads some non-performance critical activities from the SQL-processing ICs 44A and 44B and performs these functions in software. These functions include the on-demand collection of data base statistics for query optimization and the storage and implementation of stored procedures. One of these procedures allows the expansion card to perform the SQL Audit function.

The SQL in-silicon section 64 includes the SQL-processing integrated circuit or circuits 44A and 44B, as well as associated database memory 46A and 46B. The SQL-processing ICs 44A and 44B perform the remainder of the SQL-processing. The functions performed by the SQL-processing ICs 44A and 44B are either critical to query performance or closely tied to the internal database system catalogs 140, or both.

In addition to processing standard SQL statements, the SQL-processing ICs 44A and 44B support several new SQL extensions that give the application developer access to some very powerful features. All of these features are very difficult for a processor to perform and, because of their speed, can be of tremendous value for an artificial intelligence application. These features include Proximity Match; Prefix Match; and a Learning feature.

The proximity feature allows an entire table to be examined to identify the record that most closely resembles the key presented. This is specified in the “where” clause of an SQL select statement. To perform a proximity match, the SQL-processing IC uses a Euclidean or Manhattan distance algorithm on 4, 8, 16 or 32-bit boundaries and examines as many as 100 million keys per second. This feature is designed to support real time Al recognition and learning applications.

Adding this feature, covered in U.S. Pat. No. 6,226,710, to the SQL-processing IC 44 opens new doors for systems that deal with fuzzy data where a best match is desired.

A special prefix table type is specified on the SQL “Create Table” and “Select” commands. Prefix tables were conceived to support IPV4 Internet protocol matching. The feature, described in U.S. Pat. No. 6,353,873 entitled “APPARATUS AND METHOD TO DETERMINE A LONGEST PREFIX MATCH IN A CONTENT ADDRESSABLE MEMORY”, is used today by the telecom industry. The feature supports the storage of prefixes that are searched for a longest matching prefix (up to 128 bits). This feature allows an application to add prefixes (most significant bits) of specified lengths and associated columnar data to a prefix table. A longest prefix match returns columnar data associated with the prefix that fully matches the longest series of most significant bits of the key.

This type of match is very difficult for a processor to perform and thus is not currently used outside of telecom routing applications. The SQL-processing IC 44 is able to perform this type of match in 200 nanoseconds. This enhances rule-based applications that use the prefix table to store “yes/no” branches for a 128-node binary decision tree. A single lookup in the prefix table, with a key constructed from current environmental conditions, yields a decision.

The learning feature is a common paradigm in the telecom industry but totally unfamiliar in the SQL environment. It is particularly useful when making logical to physical mappings and will be useful to AI applications. The optional learn mode is specified on SQL Insert, Update and Delete commands. It essentially combines a Seek with these commands. By performing the common sequence of a Seek followed by an Insert, Update or Delete, the application can improve performance.

Table 1 shows both Normal and Learn mode SQL operation if the target record exists and a SQL Insert, Update, or Delete function is performed.

TABLE 1
Definition of Learning Feature when a Record Exists

| | Insert | Update | Delete |
|---|---|---|---|
| Normal | Return duplicate key | Replace the stored | Delete Record |
| mode | error (if unique key); | columnar data with | |
| | else add new record | the new data | |
| Learn | Return status & | Return status & | Delete record |
| mode | existing columnar | existing columnar | and return |
| | data-as though it | data-as though it | status and |
| | were a seek | were a seek | columnar data |

In addition to using the features of U.S. Pat. No. 6,226,710 to accelerate memory accesses, the following strategies are utilized to achieve optimum SQL-processing performance: parallel combinatorial logic; pipelining; and interleaved memory I/O.

By using multiple combinatorial logic blocks, the SQL-processing IC 44 is able to simultaneously perform many tasks that a processor must perform serially. An example of this is the SQL aggregate functions (e.g. Min, Max, Average, etc.). Combinatorial logic within the SQL-processing IC 44 is continuously updating these aggregates in the background as a dataset is created. If a query calls for one of these aggregates, it is immediately available.

Pipelining is a common technique used in silicon to gain performance. Working much like an assembly line, the SQL-processing IC processes queries in stages. While one query is being executed, the next query is planned and the query following it is parsed. Similarly, while the host is writing a query to the SQL-processing IC or reading a dataset from the SQL-processing IC, the IC will be processing subsequent queries. Within all of the modules, pipelining is utilized to further accelerate processing.

The SQL-processing IC's main performance constraint is memory I/O. The UTCAM-Engine IC of U.S. Pat. No. 6,226,710 already reduces memory latency by leveraging synchronous burst I/O. Another strategy to additionally minimize memory I/Os is utilizing the bank feature of SDRAM memory to interleave I/O from multiple tables and thus pipeline them.

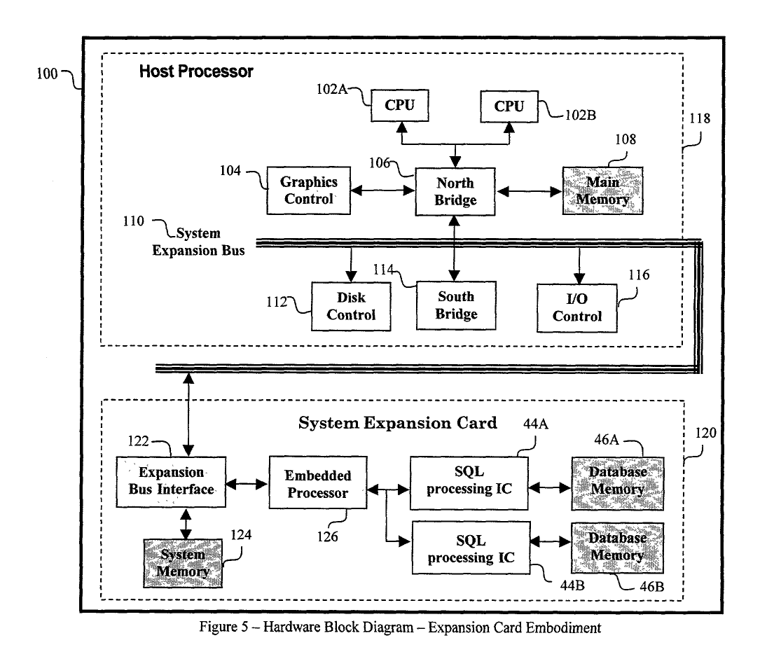

Referring to FIG. 5, one embodiment of the distributed database management system 100 consists of one or more SQL-processing ICs 44A and 44B residing on a system expansion card 120. One or more CPUs 102A and 102B communicate with a North Bridge IC 106 which is part of a processor specific chip-set that interfaces the processors with all other system components. The North Bridge IC 106 communicates with various system components such as a graphics controller IC 104, main system memory 108, a South Bridge IC 114, a disk controller IC 112, and an IO controller IC 116.

The North Bridge IC 106, also called a system controller, has the following functions: host-PCI bridge, memory controller and cache L2 controller (except in motherboards for Pentium Pro, Pentium II and superiors, where the cache L2 controller is in the processor itself). The South Bridge IC 114, also called a peripheral controller, has the following functions: host-PCI-ISA bridge, interrupt controller, DMA controller, and control of the “on board” peripherals (floppy disk unit controller, serial port, parallel port IDE ports).

A system expansion bus 110 such as PCI or the like, is used to communicate with various system expansion cards to extend the capabilities of the system. The North Bridge IC 106, communicates via the system expansion bus 110 to the remaining IC-based portion of the SQL database management system resident on a system expansion card 120. A memory controller/system expansion bus interface circuit 122 communicates to the host processor 118 over the system expansion bus 110. In turn, the memory controller/system expansion bus interface circuit 122 provides an interface to the system memory 124 from both the system expansion bus 110 and from the embedded processor 126. The embedded processor 126 can be a MIPS, ARM, Power PC, Pentium or similar processor. The embedded processor 126 communicates with one or more dedicated SQL-processing integrated circuits 44A and 44B, which are in communication with the corresponding database memories 46A and 46B. While only two IC sets are shown, any number may be used as required to implement additional database memory.

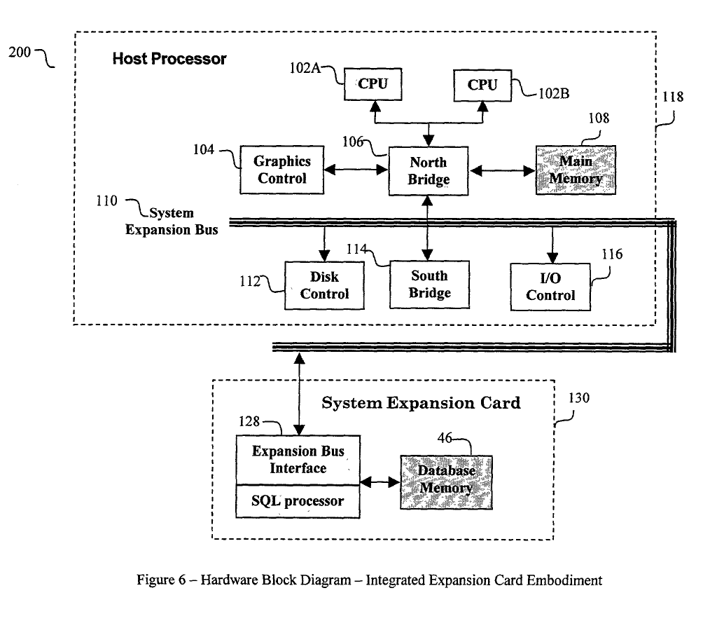

Referring to FIG. 6, another embodiment 200 of the distributed database management system consists of the in-silicon SQL processor portion of the present invention integrated into a single IC with a system expansion bus interface such as PCI or the like on a system expansion card 130. One or more CPUs 102A and 102B communicate with the North Bridge IC 106 which is part of a processor specific chip-set that interfaces the processors with all other system components. The North Bridge IC 106 communicates with various system components such as a graphics controller IC 104, main system memory 108, a South Bridge IC 114, a disk controller IC 112, and an IO controller IC 116. A system expansion bus 110 such as PCI or the like, is used to communicate with various system expansion cards to extend the capabilities of the system. The North Bridge IC 106, communicates via the system expansion bus 110 to the integrated IC 128 resident on the system expansion card 130. The integrated IC 128 communicates with the database memory 46 where the contents of the SQL database are stored. In this embodiment, the SQL optimization statements are processed by the host processor 118.

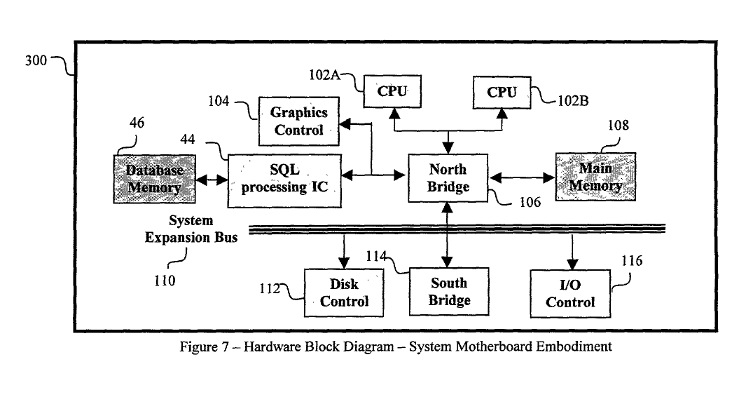

In another embodiment, referring to FIG. 7, the IC-based management system 300 of the present invention is implemented on a system motherboard. One or more CPUs 102A and 102B communicate with the North Bridge IC 106 which is part of a processor specific chip-set that interfaces the processors with all other system components. The North Bridge IC 106 communicates with various system components such as a graphics controller IC 104, main system memory 108, a South Bridge IC 114, a disk controller IC 112, an IO controller IC 116, and a SQL-processing IC 44. The SQL-processing IC communicates with the database memory 46 where the contents of the SQL database are stored. In this embodiment, the SQL optimization statements are processed by the CPUs 102A and 102B. A system expansion bus 110 such as PCI or the like, is used to communicate with various system expansion cards to extend the capabilities of the system.

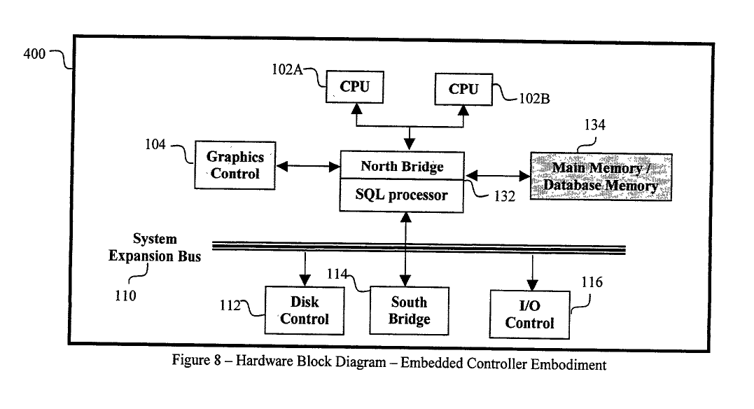

In another embodiment, referring to FIG. 8, the IC-based management system 400 of the present invention is embedded in a processor chip-set on a system motherboard. One or more CPUs 102A and 102B communicate with the integrated North Bridge and SQL processor IC 132 which interfaces the processors with all other system components and performs SQL-processing. The North Bridge/SQL processor IC 132 communicates with various system components such as a graphics controller IC 104, main system memory and database memory 134 which contains program instructions, data and the SQL database, a South Bridge IC 114, a disk controller IC 112, and an IO controller IC 116. In this embodiment, the SQL optimization statements are processed by the CPUs 102A and 102B. A system expansion bus 110 such as PCI or the like, is used to communicate with various system expansion cards to extend the capabilities of the system.

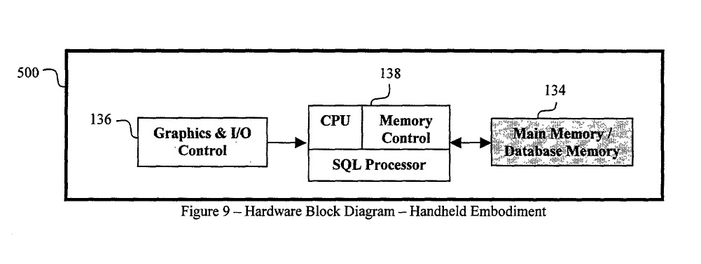

In a hand held embodiment, shown in FIG. 9, the IC based management system 500 of the present invention is embedded in a single integrated circuit 138 with a general purpose processor core and a memory controller. This IC communicates with graphics and I/O controller 136 and the combined main system memory and database memory 134, which contains program instructions, data and the SQL database. In this embodiment, the SQL optimization statements are processed by the CPU embedded in the IC 138.

It should be understood by those skilled in the art that obvious structural modifications can be made without departing from the scope of the invention. Accordingly, reference should be made primarily to the accompanying claims, rather than the foregoing specification, to determine the scope of the invention.

Having thus described the invention, what is claimed is:

1. A distributed SQL database management system comprising at least one dedicated SQL-processing integrated circuit.

2. The database management system of claim 1 in which the SQL-processing integrated circuit resides on a system expansion card.

3. The database management system of claim 1 in which the SQL-processing integrated circuit further comprises an expansion bus interface.

4. The database management system of claim 1 in which the SQL-processing integrated circuit resides on a system motherboard.

5. The database management system of claim 1 in which the SQL-processing integrated circuit is embedded in a processor chip-set on a system motherboard.

6. The database management system of claim 1 in which the SQL-processing integrated circuit is embedded in a single integrated circuit with a general purpose processor core and a memory controller.

7. A distributed SQL database management system comprising:
an SQL domain layer;
an SQL optimization layer; and
an SQL in-silicon layer.

8. The database management system of claim 7 in which the SQL domain layer comprises:
an open data base connectivity interface;
a plurality of application programs in communication with the interface; and
a database administrator in communication with the interface.

9. The database management system of claim 7 in which the SQL optimization layer comprises:
an embedded processor; and
system memory in communication with the embedded processor.

10. The database management system of claim 7 in which the SQL in-silicon layer comprises:
a plurality of dedicated SQL-processing integrated circuits; and
database memory in communication with the SQL integrated circuits.

11. A dedicated SQL-processing integrated circuit comprising a plurality of SQL combinatorial logic blocks for processing SQL queries.

12. The SQL-processing integrated circuit of claim 11 further comprising a content-addressable memory engine in communication with the SQL-processing blocks.

13. The SQL-processing integrated circuit of claim 11 further comprising a learning mode SQL extension.

14. The SQL-processing integrated circuit of claim 11 further comprising a proximity match SQL extension.

15. The SQL-processing integrated circuit of claim 11 further comprising a longest prefix match SQL extension.

16. The SQL-processing integrated circuit of claim 11 further comprising automatic updating of SQL aggregate functions.

17. The SQL-processing integrated circuit of claim 11 in which a first logic block comprises an executive logic block.

18. The SQL-processing integrated circuit of claim 11 in which a second logic block comprises a parse SQL logic block.

19. The SQL-processing integrated circuit of claim 11 in which a third logic block comprises a plan query execution logic block.

20. The SQL-processing integrated circuit of claim 11 in which a fourth logic block comprises an execute query logic block.

21. The SQL-processing integrated circuit of claim 20 further comprising a math co-processor in communication with the execute query logic block.
